(19) United States
(12) Patent Application Publication
(10) Pub. No.: US 2003/0053141 A1
(43) Pub. Date: Mar. 20, 2003

(54) System for transferring a digital image from a photographer to a fulfillment center to generate a photographic process

(75) Inventors: Rodney Thomas Whisnant, Austin, TX (US); Kevin Eugene McFarland, Austin, TX (US); Graham Rodney McFarland, Parker, CO (US)

Correspondence Address: PATTON BOGGS, PO BOX 270930, LOUISVILLE, CO, 80027, US

(73) Assignee: Express Digital Graphics, Inc.

(21) Appl. No.: 09/960,162

(22) Filed: Sep. 20, 2001

(51) Int. Cl. H04N 1/21; H04N 1/23; H04N 1/00

(52) U.S. Cl. 358/402; 358/302

(57) ABSTRACT

A system for generating a photographic product from a digital image. A gateway server receives a request from a photographer for a list of options for photographic products. The gateway server transmits a display of a list of options to the photographer. The photographer submits an order for a photographic product to the gateway server. The gateway server then transmits the order to a fulfillment center to process the order. The gateway server then transmits routing information to the photographer for transmitting a digital image to the fulfillment center.

### FIELD OF THE INVENTION

This invention relates to an electronic system for providing a photographer with services for fulfilling orders to generate photographic products from digital images. More particularly, this invention relates to an Internet based system for determining a fulfillment center to process an order for photographic product to be made from a digital image and for providing routing information to transmit the digital image to the fulfillment center.

### PROBLEM

Digital cameras have proliferated greatly as the quality of digital images taken has increased and the price of the cameras has decreased. Today, many professional photographers use digital cameras to take portraits of people at events and for in-studio sittings. These professional photographers desire to print the digital images taken on traditional photographic paper to make the photographs more like traditional pictures taken with conventional cameras. Furthermore, the use of digital camera to take digital images as pictures has made the process of placing the image on another product easier. For example, the use of digital images makes it easier to place the image on a coffee mug, t-shirt or calendar. For purposes of this discussion, these items will be termed photographic products. A photographic product is any product that is produced with the digital image taken from a camera.

Therefore, there is a need for a system that can find a producer of a desired product and that allows a photographer to quickly place an order for these products. This type of system could be used by professional and novice photographers alike to find producers and quickly place orders for products.

### SOLUTION

The above and other problems are solved and an advance in the art is made by the digital image transfer system of this invention. This system uses the Internet to allow a photographer to find a producer of a photographic product and place an order. The present invention allows a gateway server provide a photographer with a list of fulfillment centers that can complete the order. The gateway server acts as a middle man by taking a photographer's needs and finding fulfillment centers that can meet the needs of the photographer. The gateway can then deliver the order to a fulfillment center and transmit the preferred method to deliver the digital image from the photographer to the fulfillment center. For purposes of this discussion, a fulfillment center is an entity that produces a product from a given digital image. For example, a fulfillment center may be a photographic laboratory that prints photographs on photograph paper, or a graphics company that places a digital image on a coffee mug, calendar, t-shirt, or some other product.

In accordance with this invention, three processing systems communicate to transfer a digital image to a fulfillment center to generate a photographic product. A photographer has a computer system which is referred to as a photographer processing unit throughout this discussion that connects to the Internet. The photographer processing unit is a server or a personal computer system that connects to the Internet via a server. A gateway processing unit which is a server that connects to the internet to communicate with a photographer processing unit to receive an order and provide routing information to a fulfillment center that generates the photographic product. The gateway processing unit also communicates with a fulfillment center processing unit to place orders and monitor the status of the order. The fulfillment center generating the photographic product has a server or computer system that connects to a server for Internet connection and is referred to as a fulfillment center processing unit.

In accordance with this invention, the gateway processing unit executes software instructions to provide the following steps for transferring a digital image to a fulfillment center to generate a photographic product. The gateway processing unit maintains a list of fulfillment centers available to generate a photographic product from the digital image. The photographic processing unit transmits a request for a list of options for photographic products that can be generated from a digital image. The gateway processing unit receives the request from a photographer for the list of options to generate the photographic products. The gateway processing unit then transmits a display of the list of options to the photographer processing unit.

The photographer processing unit displays the list of options to the photographer. The photographer then inputs an order for photographic products from a digital image. The photographer processing unit then transmits the order to the gateway processing unit.

The gateway processing unit receives the order from the photographer processing unit. The order may contain parameters for selecting a fulfillment center to process the order. The parameters may include the type of products to be generated, location of the fulfillment center, a particular fulfillment center, time frame for processing the order, and the price for the photographic products.

The gateway processing unit then determines which fulfillment center will process the order. The gateway processing unit then transmits routing information to the photographer processing unit. The routing information is information for transmitting the digital image to the fulfillment center selected to process the order. The gateway processing unit then transmits the order to the selected fulfillment center.

The gateway processing unit may receive the digital image from the photographer processing unit for transmission to the fulfillment center processing unit of the fulfillment center processing the order. The gateway processing unit may receive the digital image when the fulfillment processing unit is not connected to the internet or is not available to receive the digital image. The digital image is stored in a memory and the gateway processing unit then transmits the fulfillment center processing unit at a later time when the fulfillment processing unit is connected to the internet and ready to receive the digital image.

After the digital image is transmitted by the photographer processing unit, the photographer processing unit transmits a confirmation to the gateway processing unit. The confirmation indicates that the digital image has been transmitted to the fulfillment center processing unit. The gateway processing unit receives the confirmation from the photographer and may use the confirmation to monitor the status of the order.

When an order is completed by a fulfillment center, the fulfillment center processing unit transmits a confirmation to the gateway processing unit that the order has been completed. The confirmation is received by the gateway processing unit which updates a record of the order to indicate that the order has been fulfilled.

The gateway processing unit also monitors the order to receive payment from the photographer and distribute the payment to the fulfillment center. When an order is received, the gateway processing unit debits an account of the photographer placing the order. The gateway processor then receives a transfer of funds the said photographer. When the photographer transmits funds, the gateway processing unit credit the funds to the photographer's account. In some embodiments, the transfer of funds may be an electronic transfer in which the photographer submits a credit card account number or a bank account number. In these embodiments, the gateway processing unit may wait to transmit the order to the fulfillment center processing unit until the funds are received.

After the funds are received from the photographer, the gateway processing unit credits the funds received from the photographer to an account of the fulfillment center processing the order. The gateway processor may also periodically debit a service charge to the account of the fulfillment center for use of this service.

In one embodiment, the gateway processor maintains a count of the number of orders that the fulfillment center receives. After the fulfillment center receives a specified number of orders, the gateway processing unit may debit a transactional charge for each additional order received by a fulfillment center.

The gateway processing unit may also maintain a web page listing the fulfillment centers available to process orders to allow a photographer to view the fulfillment center available to process orders. The web page may contain hyper-link text pointing to web pages of each fulfillment center listing the prices, products and service available from a particular fulfillment center.

The photographer processing unit executes software which executes the following operations to provide the services in accordance with this invention. The photographer processing unit begins by establishing a connection the gateway processing unit. The photographer processing unit then receives an input from a photographer requesting a list of options available. The request may include parameters such as fulfillment center name, fulfillment center locations, photographic products desired, prices, and services provided. The request is then transmitted to the gateway processing unit which responds by transmitting a display showing the options available. The photographer processing unit receives the display of the list of options available and displays the list to the photographer. The photographer processing unit then receives an input of the order and transmits the order to the gateway processing unit. The order may contain a graphics instructions set for graphics to be added to the digital image. This graphic instruction set may also be transmitted with the digital image to the fulfillment center processing unit at a later time.

In response to transmitting the order, the photographer processing unit receives the routing information for the digital image from the gateway processing unit. Upon receiving the routing information, the photographer processing unit transmits the digital image using the routing information. The routing information include instructions to transmit the digital image directly to a fulfillment center processing unit, transmit the digital image to the gateway processor, or store the digital image to a media for delivery of the digital image via mail or other courier service. After the digital image is transmitted, the photographer processing unit transmits a confirmation to the gateway processing unit that the digital image was transmitted. The photographer processing unit may also transmit account information to the gateway processing unit for payment of the order.

In accordance with this invention, each fulfillment center has a fulfillment center processing unit which connects to the Internet and executes the following instructions to receive a digital image and generate a photographic product. The fulfillment center processing unit receives an order for photographic products from the gateway processing unit and receives the digital image from either the gateway processing unit or the photographer processing unit. The order is then processed to generate the photographic product from the digital image.

The fulfillment center processing unit may store the digital image in a memory to process the order at a later time. When the fulfillment center processing unit stores the digital image, the digital image must be deleted from memory. In a preferred embodiment, the digital image is deleted either after a specified period of time or after the order is processed.

To allow the gateway processing unit to monitor the status of an order, the fulfillment center processing unit transmits a status of the order periodically to the gateway processing unit. The transmitted status updates may include a confirmation when an order is received and a confirmation when a digital image is received. The fulfillment center processing unit may also transmit a status report indicating the availability of the fulfillment center to fulfill subsequent orders.

In order to generate a photographic product, the fulfillment center processing unit must first generate a proof of a desired photographic image from the digital image and a graphic instruction set which includes instructions for adding graphics to the digital image. The graphic instruction set may either be received in the order or may be received from the photographer processing unit with the digital image.

### BRIEF DESCRIPTION OF THE DRAWINGS

The above and other features and aspects of this invention are described in the Detailed Description given below and shown in the following drawings:

FIG. 1 illustrating a block diagram of computers systems connected to the Internet to provide service in accordance with this invention;

FIG. 2 illustrating a block diagram of a processing system of a computer system that provides service in accordance with this invention;

FIG. 3 illustrating a flow diagram of a process executed by a gateway processor in accordance with this invention;

FIG. 4 illustrating a flow diagram of a process executed by a photographer processing unit in accordance with this invention;

FIG. 5 illustrating a flow diagram of a process executed by a fulfillment center processing unit in accordance with this invention;

FIG. 6 illustrating a flow diagram of a process for updating accounts executed by the gateway processing unit in accordance with this invention;

FIG. 7 illustrating a flow diagram of a process for monitoring an order executed by a gateway processing unit in accordance with this invention; and

FIG. 8 illustrating a flow diagram of a process for processing an order executed by the fulfillment center processing unit in accordance with this invention.

### DETAILED DESCRIPTION

This invention relates to an Internet based service for providing photographers with a means for finding fulfillment centers that provide desired photographic products, for placing orders with the fulfillment centers, and for transferring a digital image from the photographer to the fulfillment center. For purposes of this discussion, a photographic product is a photograph on photographic paper, or any other product on which a digital image is imprinted. Some examples of such products include but are not limited to calendars, t-shirts, coffee mugs, and trading cards. Also for purposes of this discussion, a fulfillment center is a photographic laboratory or other printing shop which places a digital image onto a product. It is envisioned that this invention will provide photographers in professional photographic studios with a fast and convenient way to find fulfillment centers to fulfill orders for products from digital images that the photographer has taken.

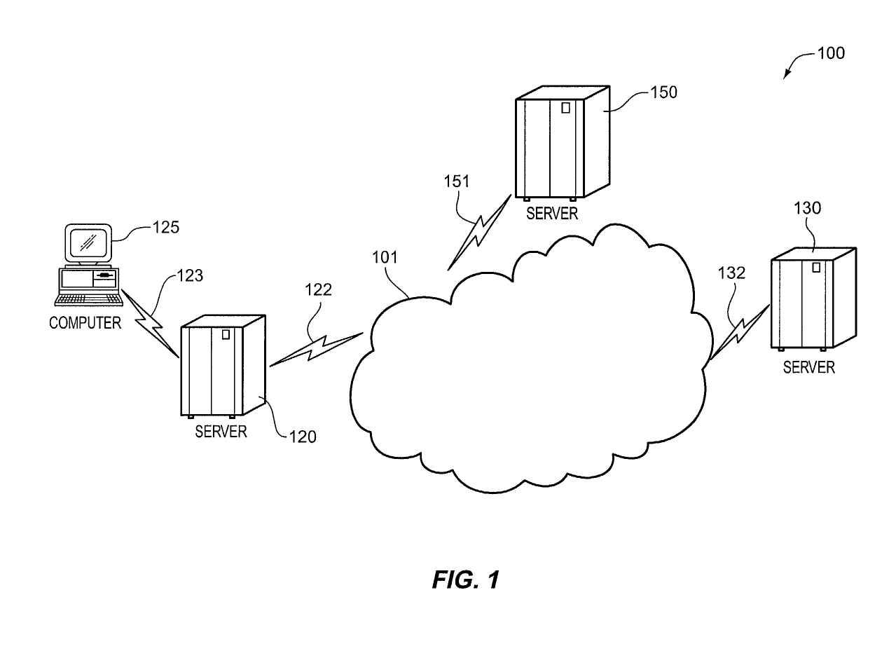

FIG. 1 illustrates the computer systems needed to provide this invention in a preferred embodiment of this invention. A photographer has a computer system 125 that connects to an Internet server 120 via communication path 123. One skilled in the art will recognize that communication path 123 may be a telephone line, a coaxial cable connection, LAN, WAN, a T1 communication line, DSL connection, or any other means of communication connection that allows computer systems to exchange data. Internet server 120 connects to Internet 101 via communications path 122. One skilled in the art will recognize that communications path 122 is any form of connection between computer systems that provides for communication between computer systems and the exact type of connection is unimportant with regards to this invention. One skilled in the art will also recognize that computer 125 and server 120 may in fact be the same computer system and the exact configuration is not important to this invention. For purposes of this discussion, the systems connecting a photographer to the Internet are termed a photographer processing unit which is a system that can execute instructions in hardware, software, or firmware to perform the processes of this invention.

A gateway server 150 connects to Internet 101 via communications path 151. One skilled in the art will recognize that any type of connection that facilitates communications with other computer systems connected to Internet 100 may be used. Gateway server 150 performs the routing and management functions of this invention to transfer orders from a photographer to a fulfillment center. For purposes of this discussion, gateway server is termed a gateway processing unit which is a processing system that can execute instructions stored in hardware, software, or firmware in order to provide processes in accordance with this invention. One skilled in the art will recognize that gateway server 150 may be connected to other computer systems and processing units that provide the processes of this invention.

Each fulfillment center that uses this service has a fulfillment center server 130 that connects to Internet 101 via communications path 132. For purposes of this discussion, fulfillment center server 130 is called a fulfillment center processing unit because although shown as a single computer system in FIG. 1. Fulfillment center server 130 may have also have one or more connected computer systems that perform the processes in accordance with this invention.

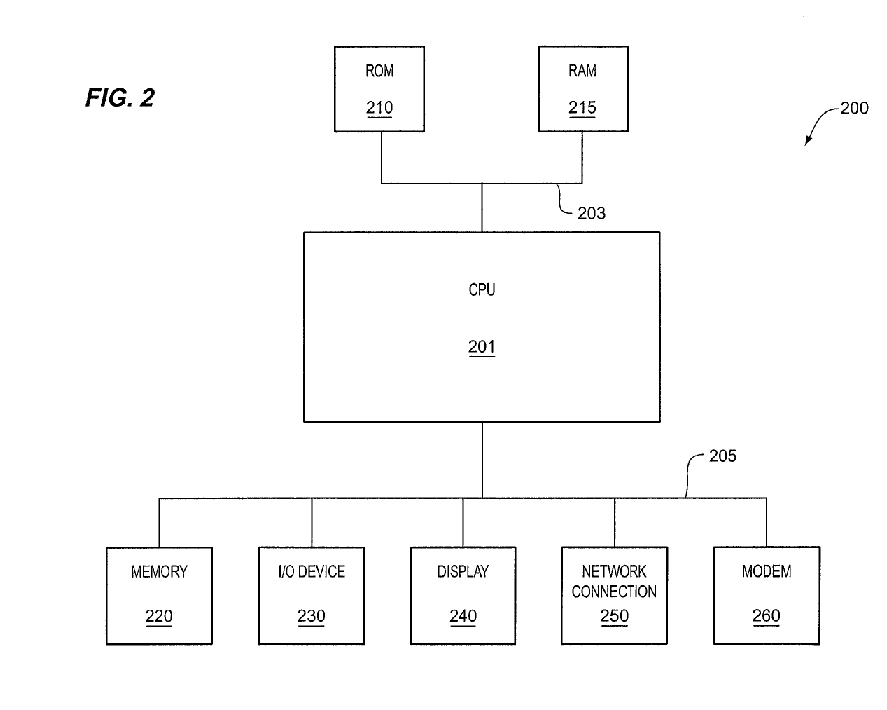

FIG. 2 illustrates a typical processing unit 200 that performs the functions of the gateway processing unit, the fulfillment processor unit, or the photographer processing unit. Central Processing Unit (CPU) 201 is a processor, microprocessor, or group of processors and/or microprocessors that execute instructions stored in a memory to perform applications. Memory bus 203 connects CPU 201 to a non-volatile memory, such as Read Only Memory (ROM) 210 and a volatile memory, such as Random Access Memory (RAM) 215. ROM 210 stores instructions such as BIOS and configuration information for processing unit 200. RAM 215 stores instructions and data needed to perform an application being executed by CPU 201.

Input/Output (I/O) bus 205 connects CPU 201 to I/O devices to receive and transmit data. A secondary memory device 220 may be connected to I/O bus 205. Secondary memory device 220 is a device that stores data or instructions to a media for later use by CPU 201. I/O device 230 may also connect to I/O bus 205. I/O device 230 is a device such as a keyboard, joystick or a mouse that allows a user to input data. Display 240 may be connected I/O bus 205. Display 240 includes device drivers and monitors needed to display data to a user. Network connection 250 may also be connected to I/O bus 205 to connect processing unit 200 to a network such as a LAN or a WAN. A common network connection 250 is an Ethernet card for a personal computer. Modem 260 may also be connected to I/O bus 205 to provide a connection over telephone line to another computer system. One skilled in the art will recognize that the devices shown in FIG. 2 are exemplary and many other types of devices may be connected to I/O bus 205.

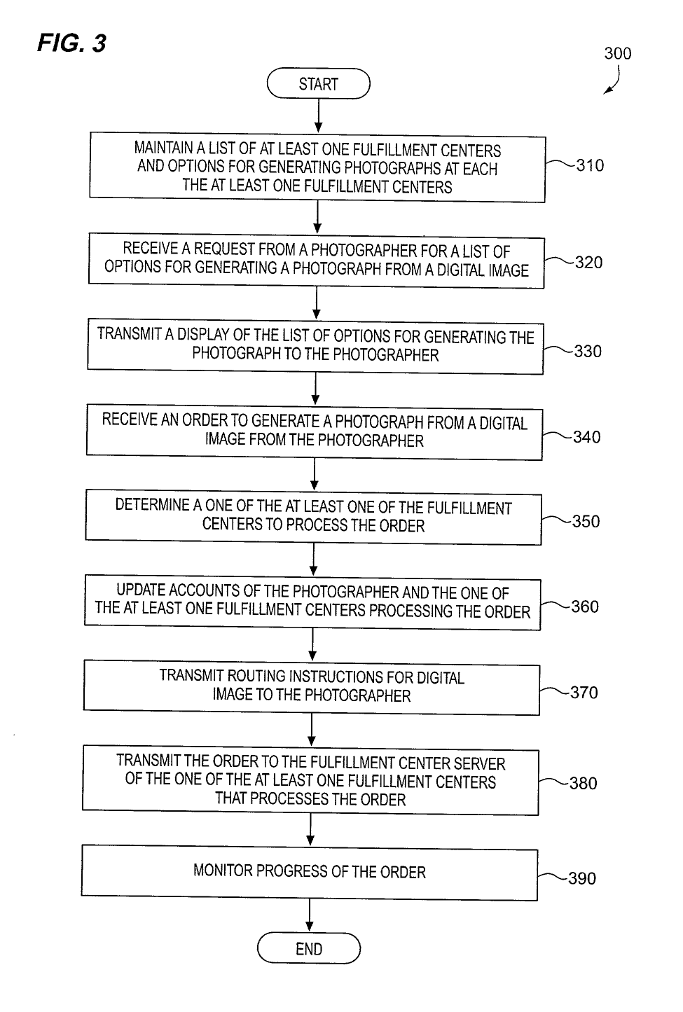

This invention relates to a system for a photographer to find a fulfillment center to process an order and for transmitting the order and a digital image to the fulfillment center. Three processing systems communicate to provide this system. FIGS. 3-8 are flow charts illustrating the processes performed by the different processing units in accordance with this invention.

FIG. 3 illustrates process 300 executed by gateway processing unit to find a fulfillment for a photographer to process an order for photographic products. Process 300 begins in step 301 by maintaining a list of at least one fulfillment centers and options provided by each of the at least one fulfillment centers for generating photographic products. In step 320, the gateway processing unit receives a request from a photographer processing unit. The request is for a list of options for photographic products to generate from a digital image. The request may include parameters from a photographer to select to fulfillment center. The parameters may include photographic products offered, location, time to produce orders, and prices.

In step 330, the gateway processing unit transmits a display of the list of options for generating a photographic products and a list of at least one fulfillment center that can fulfill the order. In step 340, the gateway processing unit receives an order from a photographic processing unit to generate a photographic product from a digital image. The order may include a graphics instruction set that is instructions for adding graphics to the digital image when the photographic product is generated.

When the order is received, the gateway processing unit determines a fulfillment center to process the order in step 350. The parameters in the request or in the order may be used to determine the fulfillment center to process the order. It should be noted that the order may specify the fulfillment center to process the order. Once the fulfillment center is determined, the gateway processing unit updates accounts of the photographer and the fulfillment center to reflect the order being placed and funds being received in step 360

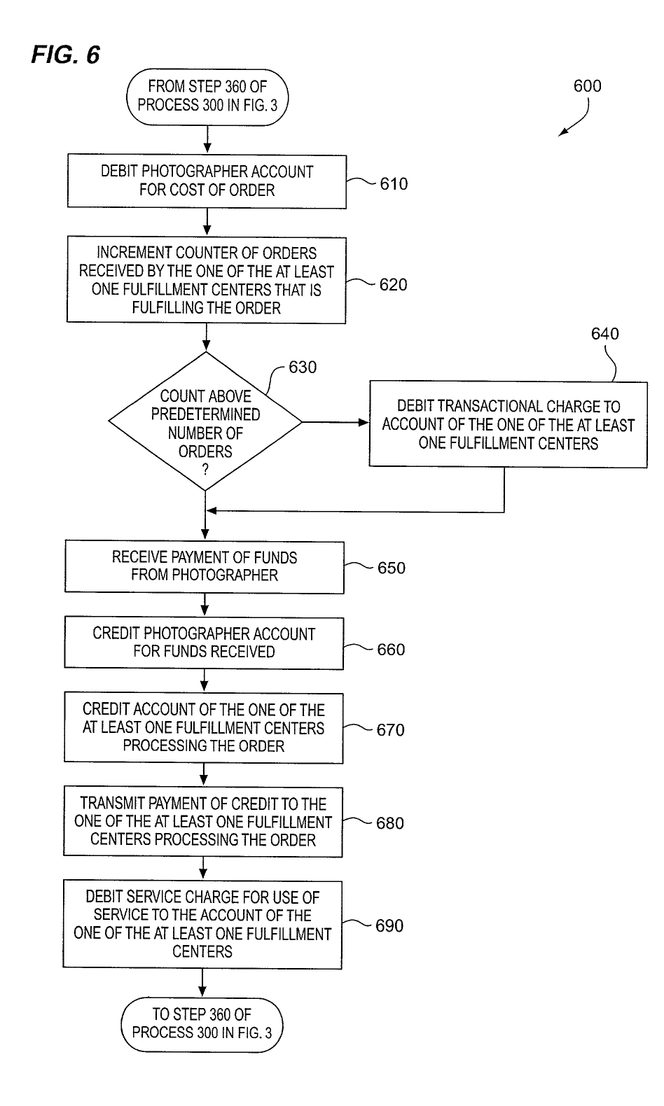

Process 600 illustrated in FIG. 6 is a process for updating accounts in step 360 in process 300. Process 600 begins in step 610 with the gateway processing unit debiting an account of the photographer for the price of the order. In step 620, the gateway processing unit increments the count of orders to the fulfillment center. This is important when the fulfillment center pays a flat fee for a predetermined number of orders and a subsequent transactional charge for each order above the predetermined number.

In step 630, the gateway processing unit determines whether the order count is greater than the predetermined number of orders. If the count is above the predetermined number of orders, the gateway processing unit debits a service charge to the fulfillment center for the order in step 640. If the count is not above the predetermined number or after the service charge is debited, the gateway processing unit receive a payment of funds from the photographer for the order in step 650. Payment may be by electronically debiting a charge account, electronically debit a bank account, an electronic transfer of funds, or receiving a check or money in a physical transfer of funds.

Once the funds are received, the gateway processing unit credits the funds to the account of the photographer in step 660. The gateway processing unit then credits funds for the order to the fulfillment center account ion step 670. In step 680, the credited funds are transmitted to the fulfillment center. The transmission may be an electronic transfer of funds or periodically sending a check or other funds to the fulfillment center. In step 690, the gateway processing unit debits a service charge for using the service to the account of the fulfillment center. The service charge may be a periodic charge. For example, a fulfillment center may pay a service charge every year, month or quarter year for a certain number of transactions in that time period.

Referring back to FIG. 3, process 300 continues in step 370 with the gateway processing unit transmitting routing instructions to the photographer processing unit. The routing instructions are instructions for transmitting the digital image from the photographer processing unit to the fulfillment center. These routing instructions may include instructions for transmitting the digital image to the gateway processing unit which in turn will transmit the digital image to the fulfillment center, instructions for transmitting the digital image to the fulfillment center by placing the image on a media and mailing the media to the fulfillment center, or transmitting the digital image to a fulfillment center processing unit via the Internet.

In step 380, the gateway processing unit then transmits the order to the fulfillment center processing unit chosen to process the order. In step 390, the gateway processing unit then monitors the progress of the order until the order is completed. Process 300 then ends.

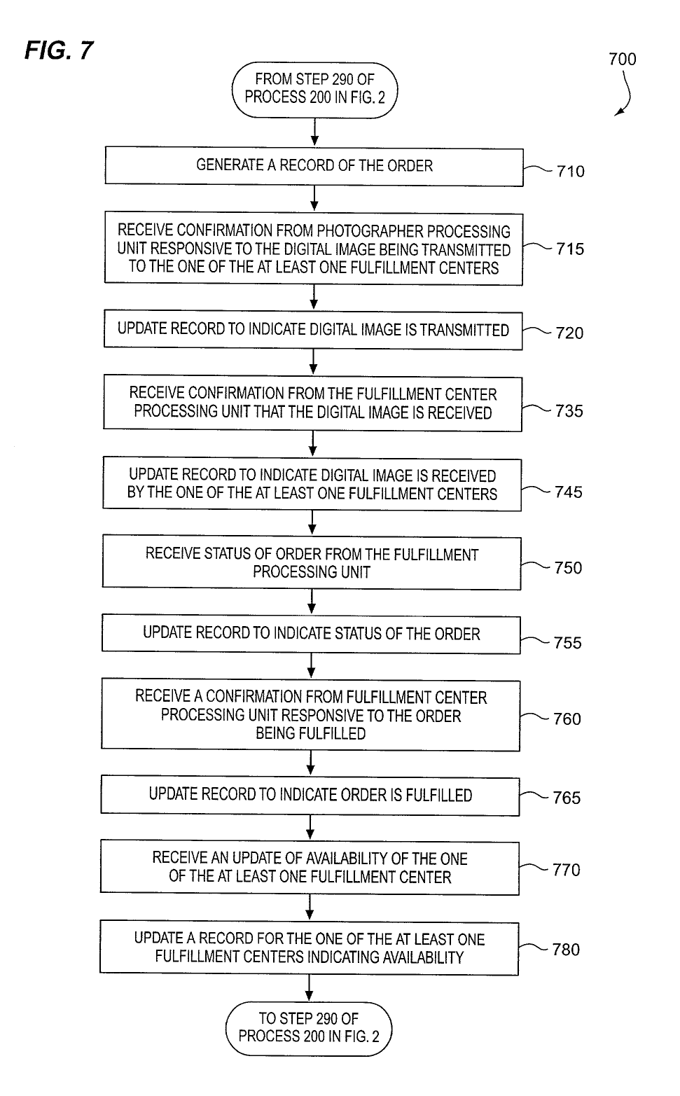

FIG. 7 illustrates a flow chart of a preferred embodiment of a process 700 performed by the gateway processing unit in step 380 of process 300. Process 700 begins in step 710 with the gateway processor generating a record for the order. The record may be a record in a database that stores record of the orders. In step 715, the gateway processing unit receives a confirmation from the photographer processing unit that the digital image has been transmitted. The record is updated by the gateway processing unit in step 720 to reflect that the confirmation was received.

In step 735, the gateway processing unit receives confirmation from the fulfillment center processing unit that the digital image was received. In step 745, the gateway processing unit updates the record to reflect the confirmation of receipt of the digital image was received from the fulfillment center processing unit. In step 750, the gateway processing unit receives a status of order from the fulfillment center processing unit. The status of the order may be received periodically so that the gateway processing unit may continually track the status of the order. In step 755, the gateway processing unit updates the record to indicate the status of the order.

In step 760, the gateway processing unit receives a confirmation from the fulfillment center processing unit when the order has been fulfilled. In step 760, the gateway processing unit updates the record to indicate the order is fulfilled. At this time, the gateway processing unit may transmit an e-mail or other notification to the photographer processing unit indicating the order has been fulfilled.

In step 770, the gateway processing unit receives an update from the fulfillment center processor indicating the availability of the fulfillment center to process subsequent orders. The gateway processing unit then updates a record for the fulfillment center indicating the availability of the fulfillment center in step 780.

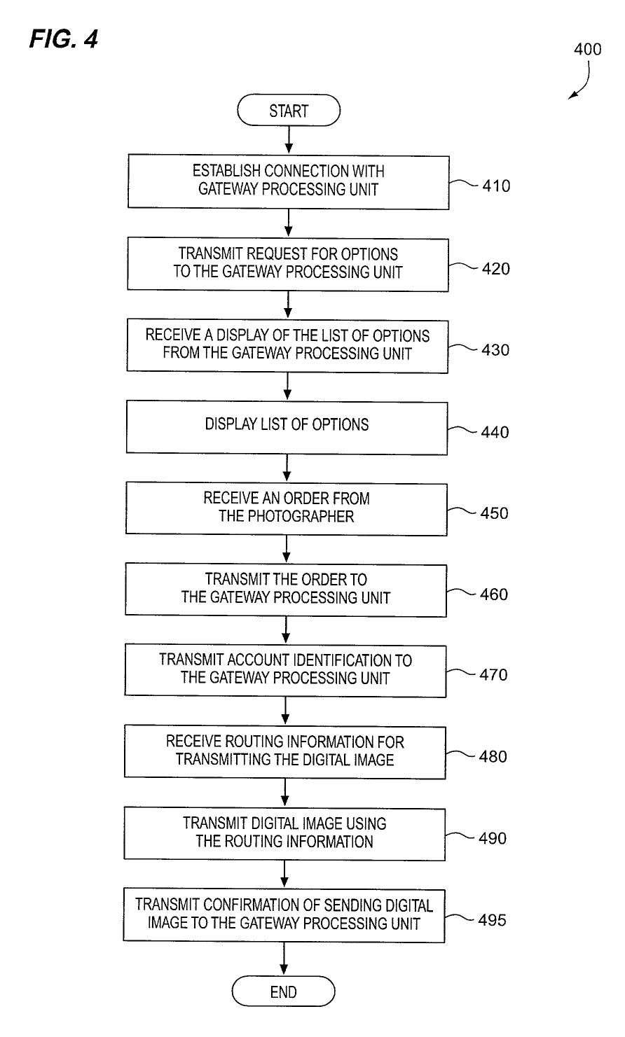

FIG. 4 illustrates a flow chart of process 400 executed by a photographer processing unit in accordance with this invention. Process 400 begins in step 410 in which the photographer processing unit establishes a connection with the gateway processing unit. The connection may be made by a direct connection, such as a dial up telephone connection or an Internet connection using software such as a web browser.

In step 420, the photographer processing unit transmits a request to the gateway processing unit for the list of options of photographic products that may be produced from the digital image. In response to the request, the photographer processing unit receives a display of a list of options for photographic products from the gateway processing unit in step 430. The display is then displayed to a photographer in step 440.

In step 450, the photographer processing unit receives an input of an order for photographic products from a photographer. The order is then transmitted to the gateway processing unit in step 460. In step 470, account information for paying for the order is transmitted to the gateway processing unit. The account information may be an account with a gateway provider, a credit card account, or a bank account to withdraw.

In step 480, the photographer processing unit receives routing information from the gateway processing unit. The routing information is instructions for transmitting the digital image from the photographer processing unit to the fulfillment center. As stated above, the routing information may tell the photographer processing unit to transmit the digital image to the gateway processing unit, transmit the digital image directly to the fulfillment center processing unit, or store the digital image to a media and send the media to the fulfillment center.

In step 490, the photographer processing unit transmits the digital image using the routing information. After the digital image is transmitted, the gateway processing unit transmits a confirmation to the gateway processing unit that the digital image was transmitted and process 400 ends.

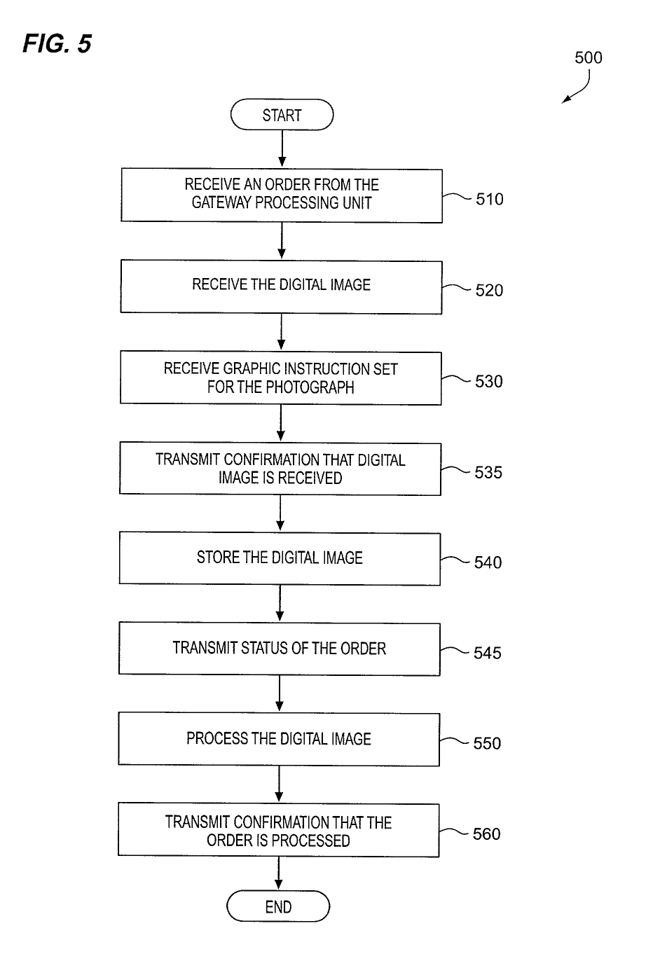

FIG. 5 illustrates a process 500 executed by the fulfillment center processing unit in accordance with this invention. Process 500 begins in step 510 with the fulfillment center processing unit receives an order from the gateway processing unit. In step 520, the fulfillment center processing unit receives the digital image. As stated above, the digital image may be received from the gateway processing unit or directly from the photographer processing unit.

In step 530, the fulfillment center processing unit receives a graphic instruction set. As stated above, the graphic instruction set may be received as pat of the order, as part of the digital image transmitted, or as a separate transmission from either the gateway processing unit or the photographer processing unit. In step 535, the fulfillment center processing unit transmits a confirmation to the gateway processing unit that the digital image was received. In step 540, the digital image and graphic instruction set are stored in a memory for later use in processing the order. In step 545, the fulfillment center processing unit periodically transmits a status of the order.

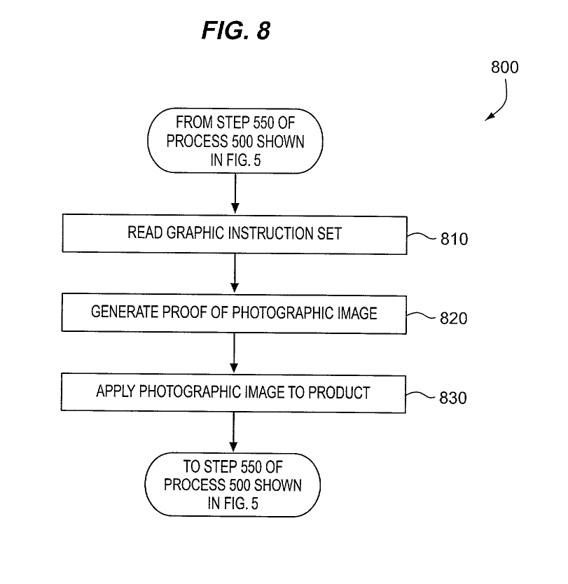

In step 550, the fulfillment center processing unit processes the digital image to generate the photographic product and fulfill the order. FIG. 8 illustrates a process 800 executed by the fulfillment center processor in step 550 to process an order. Process 800 begins in step 810 by reading the graphic instruction set. In step 820, the fulfillment center processing unit generates a proof of the digital image with the graphics added. This allows a user at the fulfillment center to correct any defects in the image with added graphics to generate a better picture When the user is satisfied with the image with added graphics, the image is applied to the desired photographic product to complete the order and process 800 ends. Referring back to FIG. 5, process 500 then ends by the fulfillment center processing unit transmitting confirmation that the order has been processed.

The above is a description of a system for allowing a photographer to order photographic products and deliver a digital image from the photographer to the fulfillment center. It is envisioned that those skilled in the will design other systems that infringe on this invention as set forth in the claims below either literally or through the Doctrine of Equivalents.

What is claimed is:

1. A system for transferring a digital image to a fulfillment center to generate a photographic product from said digital image comprising:
Instructions for directing a first processing unit to:
Maintain a list of at least one fulfillment centers available to generate a photograph from said digital image,
Receive a request from a photographer for a list of options to generate said photographic product from said digital image,
Display said list of options for generating said photographic product,
Receive an order from said photographer,
Transmit routing information to said photographer wherein said routing information is for transmitting said digital image to a one of said at least one fulfillment centers to process said order, and
Transmit said order to a fulfillment center processing unit of said one of said at least one fulfillment centers; and
A media readable by said first processing unit that stores said instructions.

2. The system of claim 1 wherein said instructions further comprise:
Instructions for directing said first processing unit to:
Receive said digital image from said photographer.

3. The system of claim 2 wherein said instructions to process said order further comprise:
Instructions for directing said first processing unit to:
Transmit said digital image to said fulfillment center processing unit.

4. The system of claim 1 wherein said instructions for directing said instructions further comprise:
Instructions for directing said first processing unit to:
Receive a confirmation from said photographer responsive to said digital image being transmitted to said fulfillment center server.

5. The system of claim 1 wherein said instructions for directing said first processing unit further comprise:
Instructions for directing said first processing unit to:
Determine said one of said at least one fulfillment centers to process said order from parameters received in said order responsive to receiving said order.

6. the system of claim 1 wherein said instructions further comprise:
Instructions for directing said first processing unit to:
Receive a confirmation from said fulfillment center processing unit responsive to said order being processed.

7. The system of claim 1 wherein said instructions further comprise:
Instructions for directing said first processing unit to:
debit a photographer account responsive to receiving said order.

8. The system of claim 7 wherein said instructions further comprise:
Instructions for directing said processing unit to:
Receive a transfer of funds from said photographer, and
credit said funds to said photographer account responsive receiving said funds are received.

9. The system of claim 8 wherein said funds are transferred electronically.

10. The system of claim 9 wherein said instructions for transmitting said order to said fulfillment center processing unit are executed responsive to receiving said funds.

11. The system of claim 8 wherein said instructions further comprise:
Instructions for directing said first processing unit to:
credit said funds received from said photographer to an account of said one of said at least one fulfillment centers responsive to receiving said funds.

12. The system of claim 1 wherein said instructions further comprise:
Instructions for directing said processing unit to:
Periodically debit a service charge to said account of said one of said at least one fulfillment centers.

13. the system of claim 12 wherein said instructions for directing said first processing unit further comprises:
Instructions for directing said first processing unit to:
Maintain a count of a number of orders that said one of said at least one fulfillment centers receives.

14. The system of claim 13 wherein said instructions further comprise:
Instructions for directing said first processing unit to:
Debit a transactional charge for said order responsive to said count being above a predetermined number.

15. The system of claim 1 wherein said instructions wherein said instructions to maintain said list of said at least one fulfillment centers comprises:
Instructions for directing said processing unit to:
Maintain a web page listing said at least one fulfillment centers with hyper-link text pointing to web pages listing said options for said at least one fulfillment centers.

16. The system of claim 1 further comprising:
Instructions for directing a photographer processing unit to:
Establish a connection with said first processing unit,
Receive said list of said at least one fulfillment centers from said first processing unit,
Display said list to said photographer,
Receive said request for said list of options of said one of said at least one fulfillment centers,
Transmit said request to said first processing unit,
Receive said list of options from said first processing unit, and
Display said list of options to said photographer; and
A second media readable by said photographer processing unit that stores said instructions.

17. The system of claim 16 wherein said instructions for directing said photographer processing unit further comprise:
Instructions for directing said photographer processing unit to:
Receive an input of said order, and
Transmit said order to said first processing unit.

18. The system of claim 17 wherein said instructions for directing said photographer processing unit further comprise:
Instructions for directing said photographer processing unit to:
Receive said routing information from said first processing unit.

19. the system of claim 18 wherein said instructions for directing said photographer processing unit to:
instructions for directing said processing unit to:
transmit said digital image to said first processing unit responsive receiving said receiving said routing information.

20. The system of claim 18 wherein said instructions for directing said photographer processing unit further comprises:
Instructions for directing said photographer unit to:
Transmit said digital image to said one of said at least one fulfillment center using said routing information responsive to receiving said routing information.

21. The system of claim 20 wherein said instructions for directing said photographer processing unit to:
Instructions for directing said photographer processing unit to:
Transmit a confirmation to said first processing unit responsive to transmitting said digital image.

22. The system of claim 17 wherein said instructions for directing said photographer processing unit to:
Instructions for directing said photographer unit to:
Transmit an account identification to said first processing unit responsive to transmitting said order.

23. The system of claim 17 wherein said order includes a graphic instruction set for said photograph.

24. The system of claim 15 wherein said request includes parameters for selecting said one of said at least one fulfillment centers to process said order.

25. The system of claim 23 wherein said parameters include a location of a fulfillment center.

26. The system of claim 23 wherein said parameters include sizes for said photographic product.

27. The system of claim 23 wherein said parameters include graphics available for said photographic product.

28. The system of claim 23 wherein said parameters include a range of prices for said photographic product.

29. The system of claim 1 further comprising:
Instructions for directing a fulfillment center processing unit to:
Receive said order from said first processing unit,
Receive said digital image, and
Process said order to generate said photographic product; and
A media readable by said fulfillment center processing unit that stores said instructions.

30. the system of claim 29 wherein said instructions for directing said fulfillment center processing unit further comprising:
Instructions for directing said processing unit to:
Store said digital image to a memory.

31. the system of claim 30 wherein said instructions for directing said fulfillment center processing unit further comprising:
Instructions for directing said fulfillment center processing unit to:
Delete said digital image from memory responsive to processing said order.

32. The system of claim 30 wherein said instructions for directing said processing unit further comprising:
Instructions for directing said fulfillment center processing unit to:
Delete said digital image from said memory responsive to a period of time being reached.

33. The system of claim 29 wherein said instructions for directing said fulfillment center processing unit further comprising:
Instructions for directing said fulfillment center processing unit to:
Transmit a status of said order periodically to said first processing unit.

34. The system of claim 29 wherein said instructions for directing said fulfillment center processing unit further comprising:
Instructions for said fulfillment center processing unit to:
Transmit an availability of said one of said at least one fulfillment centers to fulfill subsequent orders.

35. The system of claim 29 wherein said instructions for directing said fulfillment center processing unit to process said order comprises:
Instructions for directing said fulfillment center processing unit to:
Generate a proof from said digital image and a graphic instruction set.

36. The system of claim 35 wherein said instructions for directing said fulfillment center processing unit further comprises:
Instructions for directing said fulfillment center processing unit to:
Read said graphic instruction set from said order.

37. The system of claim 35 wherein said instructions for directing said fulfillment center processing unit further comprises:
Instructions for directing said fulfillment center processing unit to:
Receive said graphic instruction set from a photographer processing unit.

38.the system of claim 35 wherein said instructions for directing said fulfillment processing unit further comprising:
Instructions for directing said fulfillment center processing unit to:
Receive said digital image from said first processing unit.

39. The system of claim 35 wherein said instructions for directing said fulfillment center processing unit to:
Instructions for directing said fulfillment center processing unit to:
Receive said digital image from a photographer processing unit.

40. The system of claim 1 wherein said list of options includes photographic product sizes.

41. The system of claim 1 wherein said list of options includes types of paper available for said photographic product.

42. The system of claim 1 wherein said list of options includes graphics available to add to said digital image to generate said photographic product.

43. The system of claim 1 wherein said list of options includes said at least one fulfillment centers that provide particular options.

44. A method for generating a photographic product from a digital image comprising the steps of:
Maintaining a list of at least one fulfillment centers available to generate said photographic product from said digital image by a first processing unit;
Receiving a request from a photographer for a list of options to generate said photographic product from said digital image in said first processing unit;
transmitting said list of options for generating said photographic product from said first processing unit to a photographer processing unit;
Receiving an order from said photographer from said photographer processing unit;
Transmitting routing information to said photographer processing unit wherein said routing information is for transmitting said digital image to a one of said at least one fulfillment centers to process said order; and
Transmitting said order to a fulfillment center processing unit of said one of said at least one fulfillment centers.

45. The method of claim 44 further comprising the steps of:
Receiving said digital image in said first processing unit from said photographer processing unit.

46. The method of claim 45 further comprising the step of:
Transmitting said digital image from said first processing unit to said fulfillment center processing unit of said one of said at least one processing centers.

47. The method of claim 44 further comprising the step of:
Receiving a confirmation from said photographer processing unit responsive to said digital image being transmitted to said fulfillment center processing unit.

48. The method of claim 44 further comprising the steps of:
Determining said one of said at least one fulfillment centers to process said order from parameters received in said order responsive to receiving said order in said first processing unit.

49. The method of claim 44 further comprising the step of:
Receiving a confirmation in said first processing unit from said fulfillment center responsive to said order being processed.

50. The method of claim 44 further comprises the step of:
debiting a photographer account by said first processing unit responsive to receiving said order.

51. The method of claim 50 further comprises the step of:
Receiving a transfer of funds from said photographer, and
crediting said funds to said photographer account by said first processing unit responsive receiving said funds are received.

52. The method of claim 51 wherein said funds are transferred electronically.

53. The method of claim 51 wherein said first processing unit transmits said order to said fulfillment center processing unit responsive to receiving said funds.

54. The method of claim 51 further comprising the step of:
crediting said funds received from said photographer to an account of said one of said at least one fulfillment centers responsive to receiving said funds.

55. The method of claim 44 further comprising the step of:
Periodically debiting a service charge to said account of said one of said at least one fulfillment centers.

56. The method of claim 55 further comprising the step of:
Maintaining a count of a number of orders that said one of said at least one fulfillment centers receives by said first processing unit.

57. The method of claim 56 further comprising the step of:
Debiting a transactional charge for said order to said account of said one of said at least one fulfillment centers responsive to said count being above a predetermined number.

58. The method of claim 44 wherein said step of maintaining said list of said at least one fulfillment centers comprises the step of:
Maintaining a web page listing said at least one fulfillment centers with hyper-link text pointing to web pages listing said options for said at least one fulfillment centers.

59. The method of claim 44 further comprising the steps of:
Establishing a connection between said photographer processing unit and said first processing unit;
Receiving said list of said at least one fulfillment centers from said first processing unit in said photographer processing unit;
Displaying said list to said photographer by said photographer processing unit;
Receiving said request for said list of options of said one of said at least one fulfillment centers transmitted by said first processing unit in said photographer processing unit;
Transmitting said request from said photographer processing unit to said first processing unit;
Receiving said list of options from said first processing unit; and
Displaying said list of options to said photographer by said first processing unit.

60. The method of claim 59 further comprising the steps of:
Receiving an input of said order in said photographer processing unit; and
Transmitting said order from said photographer processing unit to said first processing unit.

61. The method of claim 60 further comprising:
Receiving said routing information in said photographer processing unit from said first processing unit.

62. The method of claim 61 further comprising the step of:
transmitting said digital image to said first processing unit responsive receiving said routing information.

63. The method of claim 61 further comprising the step of:
Transmitting said digital image to said fulfillment center processing unit of said one of said at least one fulfillment centers from said photographer processing unit using said routing information responsive to receiving said routing information.

64. The method of claim 63 further comprises the step of:
Transmitting a confirmation from said photographer processing unit to said first processing unit responsive to transmitting said digital image.

65. The method of claim 60 further comprising the step of:
Transmitting an account identification from said photographer processing unit to said first processing unit responsive to transmitting said order.

66. The system of claim 60 wherein said order includes a graphic instruction set for said photograph.

67. The method of claim 60 wherein said request includes parameters for selecting said one of said at least one fulfillment centers to process said order.

68. The method of claim 67 wherein said parameters include location of a fulfillment center.

69. The method of claim 67 wherein said parameters include sizes for said photograph.

70. The method of claim 67 wherein said parameters include graphics available for said photograph.

71. The system of claim 67 wherein said parameters include a range of prices for said photograph.

72. The method of claim 44 further comprising the steps of:
Receiving said order in said fulfillment center processing unit from said first processing unit;
Receiving said digital image by said fulfillment center processing unit; and
Processing said order by said fulfillment center processing unit to generate said photograph.

73. The method of claim 72 further comprising the step of:
Storing said digital image to a memory by said fulfillment center processing unit.

74. The method of claim 73 further comprising the step of:
Deleting said digital image from said memory in said fulfillment center responsive to processing said order.

75. The method of claim 73 further comprising the step of:
Deleting said digital image from said memory responsive to a period of time being reached.

76. The method of claim 72 further comprising the step of:
Transmitting a status of said order periodically from said fulfillment center processing unit to said first processing unit.

77. The method of claim 72 further comprising the step of:
Transmitting an availability of said one of said at least one fulfillment centers to fulfill subsequent orders from said fulfillment processing unit to said first processing unit.

78. The method of claim 72 said step of processing said order by said fulfillment center processing comprises the step of:
Generating a proof of said photograph from said digital image and a graphic instruction set.

79. The method of claim 78 wherein said step of generating said proof further comprises the step of:
Reading said graphic instruction set from said order.

80. The method of claim 78 further comprises the step of:
Receiving said graphic instruction set from a photographer processing unit.

81. the method of claim 78 further comprising the step of:
Receiving said digital image by said fulfillment center processing unit from said first processing unit.

82. The method of claim 78 further comprising the step of:
Receiving said digital image from a photographer processing unit by said fulfillment center processing unit.

83. The method of claim 44 wherein said list of options includes photographic product sizes.

84. The method of claim 44 wherein said list of options includes types of said photographic product.

85. The method of claim 44 wherein said list of options includes graphics available to add to said digital image to generate said photographic product.

86. The method of claim 44 wherein said list of options includes said at least one fulfillment centers that provide particular options.
